(19) United States
(12) Patent Application Publication
(10) Pub. No.: US 2015/0026218 A1
(43) Pub. Date: Jan. 22, 2015

(54) System and Method for Automated Document Linking

(71) Applicants: Randall W. Eckel, Tempe, AZ (US); David Gallivan, Tempe, AZ (US)

(72) Inventors: Randall W. Eckel, Tempe, AZ (US); David Gallivan, Tempe, AZ (US)

(21) Appl. No.: 13/943,722

(22) Filed: Jul. 16, 2013

(51) Int. Cl. G06F 17/30

(52) U.S. Cl. CPC G06F 17/30289
USPC 707/803

(57) ABSTRACT

The various implementations of the present invention are provided as a network computer system configured to allow for automated document linking. A group of documents can be collected into a “case” where the case is a document collection containing electronic images and metadata associated with each image. A case can be created in an “ad hoc” fashion and documents can be added to the case over time by one or more users. The cases or document collections can be electronically connected to third party systems (e.g., an Enterprise Resource Planning or “ERP” system) to provide the ability to connect electronic images and the associated metadata to the appropriate screens and functions of the third party system, thereby allowing the electronic images and metadata to be accessed from within the third party system.

### RELATED APPLICATIONS

This application claims the benefit of U.S. Provisional Patent Application No. 61/672,286, which application was filed on Jul. 16, 2012, and which application is currently pending and which application is incorporated herein by reference.

### BACKGROUND OF THE INVENTION

1. Technical Field

The present invention relates generally to the field of document management and more specifically relates to equipment and methods for identifying electronic versions of paper-based documents.

2. Background Art

Businesses, government agencies, and other organizations will often have a need to create electronic versions of paper-based documents. While there are many systems for this process, the overall process and procedures can leave much to be desired.

For example, many document capture systems are “stand-alone” systems and are not easy to integrate with other systems. This makes it difficult, if not impossible, for a business to adopt and deploy document capture systems that need to be integrated with third party systems or legacy systems.

Accordingly, without improvements in the current systems, procedures, and methods for creating and managing electronic versions of paper-based documents, the efficiency and effectiveness of organizations that wish to create and utilize electronic versions of paper-based documents will continue to be sub-optimal.

### BRIEF SUMMARY OF THE INVENTION

The various implementations of the present invention are provided as a network computer system configured to allow for automated document linking. A group of documents can be collected into a “case” where the case is a document collection containing electronic images and metadata associated with each image. A case can be created in an “ad hoc” fashion and documents can be added to the case over time by one or more users. The cases or document collections can be electronically connected to third party systems (e.g., an Enterprise Resource Planning or “ERP” system) to provide the ability to connect electronic images and the associated metadata to the appropriate screens and functions of the third party system, thereby allowing the electronic images and metadata to be accessed from within the third party system. Additionally, in at least one preferred embodiment of the present invention, a user can select specific documents for inclusion in a case by using a graphical user interface.

### BRIEF DESCRIPTION OF THE FIGURES

The preferred embodiments of the present invention will hereinafter be described in conjunction with the appended drawings, wherein like designations denote like elements, and:

FIG. 1 is a perspective view of a network computer system for automated document linking in accordance with a preferred exemplary embodiment of the present invention;

FIG. 2 is a block diagram of a server used for implementing a network computer system for an automated document system in accordance with a preferred exemplary embodiment of the present invention;

FIG. 3 is a block diagram illustrating the components of a network computer system for a automated document linking in accordance with a preferred exemplary embodiment of the present invention;

FIG. 4 is a flow chart of a method for implementing an automated document linking system in accordance with a preferred exemplary embodiment of the present invention;

FIG. 5 is a schematic diagram of a user interface for accessing an automated document linking system in accordance with a preferred exemplary embodiment of the present invention; and

FIG. 6 is a schematic diagram of a process flow initiated by the user interface of FIG. 5 for an automated document linking system in accordance with a preferred exemplary embodiment of the present invention.

### DETAILED DESCRIPTION OF THE INVENTION

The various implementations of the present invention are provided as a network computer system configured to allow for automated document linking. A group of documents can be collected into a “case” where the case is a document collection containing electronic images and metadata associated with each image. A case can be created in an “ad hoc” fashion and documents can be added to the case over time by one or more users. The cases or document collections can be electronically connected to third party systems (e.g., an Enterprise Resource Planning or “ERP” system) to provide the ability to connect electronic images and the associated metadata to the appropriate screens and functions of the third party system, thereby allowing the electronic images and metadata to be accessed from within the third party system.

The various preferred embodiments of the present invention are specifically designed to provide a user-configurable platform for creating and accessing electronic version of paper-based documents and associated metadata stored in one system from another system.

Aspects of the system are described herein with reference to flowchart illustrations and/or block diagrams of methods, apparatus (systems) and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

Additionally, various preferred embodiments of the program product may be configured to: create and modify multiple databases; track, update and store data relative to the documents and associated metadata; configure and implement various search and retrieve functions for a multitude of search requests and determinations made by users of the network computer system; track and store information about various services and fees; update and transmit search results to one or more users; and provide one or more user interfaces for accomplishing all of these functions.

In this fashion, the appropriate entities (i.e., business owners, managers, administrators, teachers, parents, students, etc.) can utilize the program product to initiate and complete a wide variety of database-related applications for the provision of electronic document management. Similarly, a program product in accordance with one or more preferred embodiments of the present invention can also be configured to perform substantially all of the steps depicted and described in conjunction with the figures below for implementing an event monitoring, tracking, and reporting system as described herein.

While the present invention will be described in detail by using various examples of a typical business environment, those skilled in the art will recognize that the equipment, processes, methods and techniques described herein have broad applicability to other environments and applications where quick and efficient access to create and manage electronic versions of paper-based documents is desirable.

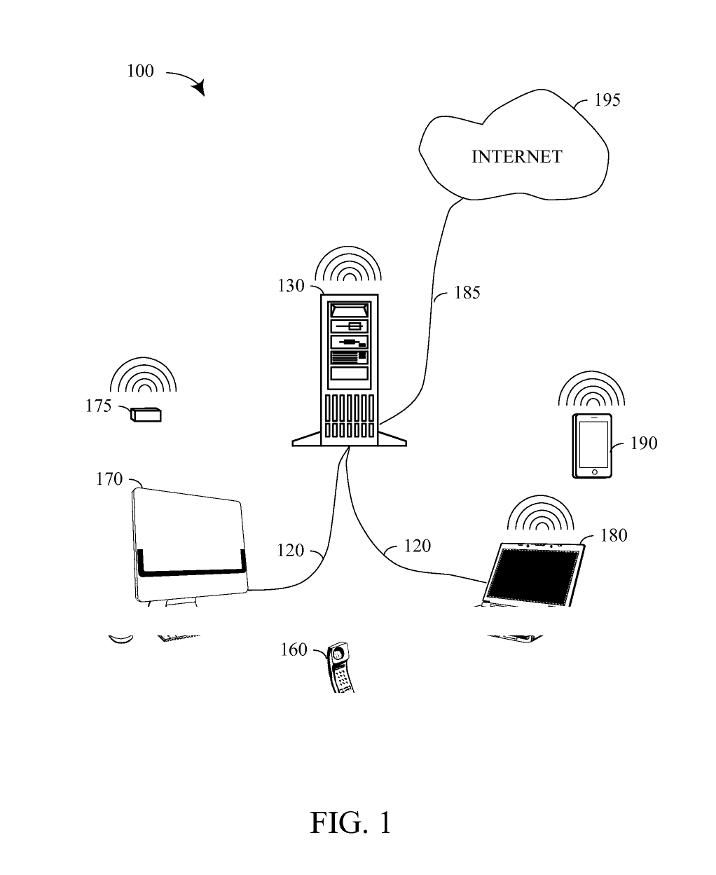

Referring now to FIG. 1, a network computer system 100 for automated document linking in accordance with a preferred exemplary embodiment of the present invention comprises: a data server 130; at least one of a desktop computer 170 or a laptop computer 180; a telephone 160; a wireless communication device 175; and an optional smartphone or Personal Digital Assistant 190 all connected or coupled via a local area network 120 to the Internet 195 via an Internet connection 185.

Taken together, the components of network computer system 100 provide a platform for creating ad hoc document collections or “cases,” as well as providing a facility for related tracking and messaging services. Network computer system 100 provides a mechanism for a group of users to efficiently and effectively create, store, monitor, and access electronic versions of paper-based documents as well as making decisions and taking actions based upon the document collections and contents when integrated and used in conjunction with third party software and systems.

In the most preferred embodiments of the present invention, network computer system 100 is configured as a system that will be used to create and access electronic documents and associated metadata, in a typical business environment. In this preferred embodiment, the group of users for network computer system 100 will typically include business owners, operators, and their employees. Further, depending on the specific preferences of the business, partners, customers, and clients may also be provided with limited access to various features and functions of network computer system 100.

Network 120 represents any suitable computer communication link or similar communication mechanism, including some combination of a hardwired connection, an internal or external bus, a connection for telephone access via a modem, standard co-axial cable lines, high-speed T1 line, radio, infrared or other wireless communication methodologies (i.e. “Bluetooth,” infrared (IR), etc.), private or proprietary local area networks (LANs) and wide area networks (WANs), as well as standard computer network communications over Internet 195 or an internal network (e.g. “intranet”) via a wired or wireless connection, or any other suitable connection between computers and computer components known to those skilled in the art, whether currently known or developed in the future. It should be noted that portions of network 120 might suitably include a dial-up phone connection, a broadcast cable transmission line, a Digital Subscriber Line (DSL), an ISDN line, or similar public utility-like access link.

In the most preferred embodiments of the present invention, at least a portion of network 120 comprises a standard Internet connection 185 between at least some of the components of network computer system 100 for providing access to additional network resources and other remote locations. Network 120 provides for communication between the various components of network computer system 100 and allows for relevant information to be transmitted from device to device. In this fashion, a user of network computer system 100 can quickly and easily gain access to the relevant data and information utilized to search, retrieve, and display information from one or more databases as described in conjunction with the preferred embodiments of the present invention.

In the most preferred embodiments of the present invention, network 120 is configured to provide relatively high-speed transmission of both audio and video data and signals and comprises at least an Internet connection 185 for transmission of data captured by one or more computers 170 or 180 and a phone 160 for transmission of an audio signal to and from a standard phone connection. The phone connection may be interfaced to a standard phone system typically found in most homes and commercial facilities, including for example, the existing “land line” phone system infrastructure and/or digital cellular phone communication systems.

In addition to the other components shown in FIG. 1, a wireless communication access device 175 may be communicatively coupled to network 120 and may be type any wireless communication mechanism that is known to those skilled in the art to provide for wireless communication between network 120 and the various devices associated with network 120, including desktop computer 170, laptop computer 180 and phone 160 as well as smart phone 190. The most preferred embodiments of an acceptable wireless communication access device may comprise any type of wireless bridge, wireless router, or wi-fi “hotspot.”

Regardless of the specific components, physical nature, and topology, network 120 serves to logically and communicatively link the physical components of network computer system 100, thereby enabling stable and consistent communication between the components. This is especially important because in many preferred embodiments of the present invention, data server 130, desktop computer 170, and laptop computer 180 may be geographically remote and/or physically separated from each other.

Data server 130 represents a relatively powerful computer system that is made available to desktop computer 170, laptop computer 180, and/or phone 190 via network 120. Various hardware components (not shown this FIG.) such as external monitors, keyboards, mice, tablets, hard disk drives, recordable CD-ROM/DVD drives, jukeboxes, fax servers, magnetic tapes, and other devices known to those skilled in the art may be used in conjunction with data server 130. Data server 130 may also provide various additional software components (not shown this FIG.) such as database servers, web servers, firewalls, security software, and the like. The use of these various hardware and software components is well known to those skilled in the art.

Given the relative advances in the state-of-the-art computer systems available today, it is anticipated that functions of data server 130 may be provided by many standard, readily available data servers. This may also include the deployment of multiple inter-connected and redundant data servers 130 to enhance the availability and reliability of the functions provided by data server 130. Depending on the desired size and relative power required for data server 130, storage area network (SAN) technology may also be deployed in certain preferred embodiments of the present invention. Additionally, various biometric and identification verification devices for identifying users and controlling access as well as creating and verifying digital signatures (i.e., electronic signature processing) may also be included.

Desktop computer 170 may be any type of computer system known to those skilled in the art that is capable of being configured for use with network computer system 100 as described herein. It should be noted that no specific operating system or hardware platform is excluded and it is anticipated that many different hardware and software platforms may be configured to create computer 170. As previously explained in conjunction with data server 130, various hardware components and software components (not shown this FIG.) known to those skilled in the art may be used in conjunction with computer 170. It should be noted that in the most preferred embodiments of the present invention, desktop computer 170 is linked (via wired or wireless connection) to its own LAN or WAN and has access to one or more additional data servers (not shown this FIG.).

In addition as shown in FIG. 1, a telephone 160 may be used in conjunction with computer 170 to allow audio messages and alerts to be communicated to telephone 160. In this application, telephone 160 has been communicatively coupled to or otherwise interfaced with the standard telephone communication infrastructure associated with one or more users of network computer system 100. Similarly, audio messages and alerts may be communicated to smartphone 190.

Similarly, laptop computer 180 may be any type of relatively lightweight portable computer system known to those skilled in the art that is capable of being configured for use with network computer system 100 as described herein. This includes tablet computers (e.g., iPad®), pen-based computers and the like. Computer 180 may also be configured to allow the transmission and reception of audio signals, messages, and alerts via server 130 and network 120.

Additionally, netbooks, tablets, handheld and palmtop devices are also specifically included within the description of devices that may be deployed as a laptop computer 180. It should be noted that no specific operating system or hardware platform is excluded and it is anticipated that many different hardware and software platforms may be configured to create laptop computer 180. As previously explained in conjunction with data server 130, various hardware and software components (not shown this FIG.) known to those skilled in the art may be used in conjunction with laptop computer 180. It should also be noted that in the most preferred embodiments of the present invention, laptop computer 180 is linked to its own LAN or WAN and has access to its own data server (not shown this FIG.).

In general, the communication between devices associated with data server 130 will be data associated with the electronic documents that are created and accessed by the users of system 100. The users of desktop computer 170 and/or laptop computer 180 may be program administrators, managers, clients, employees, etc. who are seeking to access and use information contained in electronic versions of paper-based documents.

It should be noted that while FIG. 1 shows only a single desktop computer 170 and a single laptop computer 180, it is anticipated that the most preferred embodiments of the present invention will comprise dozens or even hundreds of computers 170 and laptop computers 180. Each of these computers 170 and 180 will be configured to access data server 130 in an appropriately secure way so as to accomplish the specific objectives of the user of the desktop computer 170 or laptop computer 180.

For example, the service provider that controls the databases stored on data server 130 may utilize desktop computer 170 or laptop computer 180 to access data server 130 and create, update or otherwise modify a given database. An operator, located in a remote location, may use desktop computer 170 or laptop computer 180 to access data server 130 to retrieve information about the electronic documents and associated metadata for the users of network computer system 100.

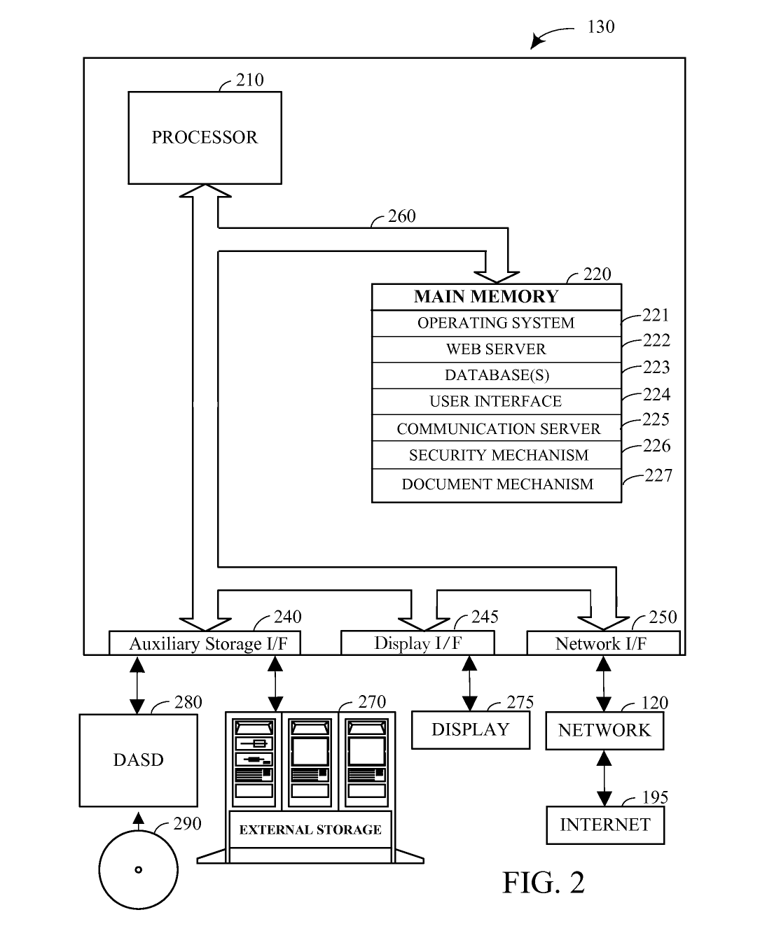

In the most preferred embodiments of the present invention, multiple desktop computers 170 and multiple laptop computers 180 will all be configured to communicate simultaneously with data server 130 and with each other via network 120. In addition, the most preferred embodiments of the present invention include a Software As A Service (SAAS) environment where data server 130 may be operated as a clearinghouse in a hosted operation. In this fashion, multiple desktop computers 170 and laptop computers 180 will have access to data server 130 and the databases stored thereon via a global computer network such as Internet 195. Data server 130 is further described below in conjunction with FIG. 2 below.

An optional printer and an optional fax machine (not shown this FIG.) may also be deployed for various hard copy data output requirements and may be considered to be any standard peripheral devices used for transmitting or outputting paper-based documents, notes, transaction details, reports, etc. in conjunction with the various requests and transactions processed by network computer system 100 (e.g., reports, statistical analyses, automated letters, etc.) Finally, it should be noted that the optional printer and the optional fax machine are merely representative of the many types of peripherals that may be utilized in conjunction with network computer system 100. It is anticipated that other similar peripheral devices will be deployed in the various preferred embodiment of the present invention and no such device is excluded by its omission in FIG. 1.

Smartphone 190 is representative of any type of cellular device or telephone that may be communicatively coupled to network computer system 100. This includes, for example, personal digital assistants (“PDAs”), Windows® mobile phone devices, Android®OS devices, Palm® OS devices, Pocket PC® devices, the Apple® iPhone® and other various types of smartphones. Those skilled in the art will recognize these various devices and others that are suitable for deployment as phone 190. While somewhat less powerful than computers 170 and 180, smartphone 190 may also be configured to wirelessly communicate with data server 130 via network 120 to send and retrieve tracking and messaging services related information to and from data server 130.

Given the standard functionality for devices that may be deployed as phone 190, this communication be provided by a wireless Internet connection (e.g. “wi-fi” or “wi-max”) or a Bluetooth® connection.

Those skilled in the art will recognize that FIG. 1 depicts a fairly standard “client/server” type communication arrangement where data server 130 is considered to be a server and computers 170 and 180 are considered to be clients of data server 130. Additionally, those skilled in the art will recognize that the functionality of data server 130 may be deployed on either of computers systems 170 and 180 in a more traditional “stand-alone” environment. In either case, the methods of the present invention are designed to minimize the amount of data that must be transferred from a database to the user of network computer system 100.

Referring now to FIG. 2, data server 130 of FIG. 1 in accordance with a preferred embodiment of the present invention represents one of many commercially available computer systems such as a Linux®-based computer system, an IBM® compatible computer system, or a Macintosh® computer system. However, those skilled in the art will appreciate that the methods and system of the present invention apply equally to any computer system, regardless of the specific operating system and regardless of whether the computer system is a more traditional “mainframe” computer, a complicated multi-user computing device or a single user device such as a personal computer or workstation.

Data server 130 suitably comprises at least one Central Processing Unit (CPU) or processor 210, an auxiliary storage interface 240, a display interface 245, and a network interface 250, all of which are interconnected via a system bus 260. Note that various modifications, additions, or deletions may be made to data server 130 illustrated in FIG. 2 within the scope of the present invention such as the addition of cache memory or other peripheral devices. FIG. 2 is not intended to be exhaustive, but is presented to simply illustrate some of the more salient features of data server 130.

Processor 210 performs computation and control functions of data server 130, and most preferably comprises a suitable central processing unit (CPU). Processor 210 may comprise a single integrated circuit, such as a microprocessor, or may comprise any suitable number of integrated circuit devices and/or circuit boards working in cooperation to accomplish the functions of a processor or CPU. Processor 210 is configured to execute one or more software programs contained within main memory 220. Although data server 130 depicted in FIG. 2 contains only a single main processor 210 and a single system bus 260, it should be understood that the present invention applies equally to computer systems having multiple processors and multiple system buses. Similarly, although system bus 260 of the preferred embodiment is a typical hardwired, multi-drop bus, any connection means that supports bi-directional communication in a computer-related environment could be used.

Auxiliary storage interface 240 allows data server 130 to store and retrieve information from auxiliary storage devices, such as external storage mechanism 270, magnetic disk drives (e.g., hard disks or floppy diskettes) or optical storage devices (e.g., CD-ROM). One suitable storage device is a direct access storage device (DASD) 280. As shown in FIG. 2, DASD 280 may be a DVD or CD-ROM drive that may read programs and data from a DVD or CD disk 290.

Display interface 245 is used to directly connect one or more displays 275 to data server 130. Display 275, which may be non-intelligent (e.g., “dumb”) terminals or fully programmable workstations, are used to provide system administrators and users the ability to communicate with data server 130. Note, however, that while display interface 245 is provided to support communication with one or more displays 275, computer data server 130 does not necessarily require a display 275, because all needed interaction with users and other processes may occur via network 120. Additionally, in certain preferred embodiments, data server 130 may have an integrated display 275.

Network interface 250 is used to connect data server 130 to network 120 and network computer system 100, including computer 170 and computer 180 of FIG. 1. Network interface 250 broadly represents any suitable way to interconnect electronic devices, regardless of whether the network comprises present day analog and/or digital techniques or via some networking mechanism of the future. Network interface 250 preferably includes a combination of hardware and software that allows communications on network 120.

Software provided in conjunction network interface 250 preferably includes a communication manager that manages communication with other computer systems or other network devices via network 120 using a suitable network protocol. Many different network protocols can be used to implement a network. These protocols are specialized computer programs that allow computers to communicate across a network. TCP/IP (Transmission Control Protocol/Internet Protocol) is just one example of a suitable network protocol that may be used by the communication manager contained within network interface 250.

It is important to note that while the present invention has been (and will continue to be) described in the context of a fully functional computer system with certain application software, those skilled in the art will appreciate that the various software mechanisms of the present invention are capable of being distributed as a program product in conjunction with an article of manufacture comprising software stored on a computer readable storage medium in a variety of forms, and that the various preferred embodiments of the present invention applies equally regardless of the particular type or storage medium used to actually carry out the distribution. Examples of computer readable storage media include: non-transitory recordable type media such as DVD and CD ROMS disks (e.g., disk 290), and transmission type media such as digital and analog communication links, including wireless communication links.

Main memory 220 suitably contains an operating system 221, a web server 222, one or more databases 223, a user interface 224, a communication server 225, a security mechanism 226, and a document mechanism 227. The term “memory” as used herein refers to any storage location in the virtual memory space of data server 130.

It should be understood that main memory 220 might not necessarily contain all parts of all components shown. For example, portions of operating system 221 may be loaded into an instruction cache (not shown) for processor 210 to execute, while other files may well be stored on magnetic or optical disk storage devices (not shown). In addition, although database 223 is shown to reside in the same memory location as operating system 221, it is to be understood that main memory 220 may consist of multiple disparate memory locations. It should also be noted that any and all of the individual software mechanisms or components shown in main memory 220 might be combined in various forms and distributed as a stand-alone program product. Finally, it should be noted that additional software components, not shown in this figure, might also be included.

Operating system 221 includes the software that is used to operate and control data server 130. In general, processor 210 typically executes operating system 221. Operating system 221 may be a single program or, alternatively, a collection of multiple programs that act in concert to perform the functions of an operating system. Any operating system now known to those skilled in the art or later developed may be considered for inclusion with the various preferred embodiments of the present invention.

Web server 222 may be any web server application currently known or later developed for communicating with web clients over a network such as the Internet. Examples of suitable web servers 222 include Apache web servers, Linux web servers, and the like. Additionally, other vendors have developed or will develop web servers that will be suitable for use with the various preferred embodiments of the present invention. Finally, while depicted as a single device, in certain preferred embodiments of the present invention web server 222 may be implemented as a cluster of multiple web servers, with separate and possibly redundant hardware and software systems. This configuration provides additional robustness for system uptime and reliability purposes. Regardless of the specific form of implementation, Web server 222 provides access, including a user interface, to allow individuals and entities to interact with graphical user interface 224, including via network 120 of FIG. 1.

Database 223 is representative of any suitable database known to those skilled in the art. In the most preferred embodiments of the present invention, database 223 is a Structured Query Language (SQL) compatible database file capable of storing information relative to various items that may be of interest to the users of network computer system 100 of FIG. 1. In the most preferred embodiments of the present invention, database 223 will comprise a plurality of information that may be useful to an organization or individual that wants to create and use electronic documents, in conjunction with a preferred embodiment of network computer system 100 of FIG. 1.

Graphical user interface 224 is a software component that provides the users of network computer system 100 of FIG. 1 a means for interacting with the various components of network computer system 100. In the most preferred embodiments of the present invention, graphical user interface 224 is a web browser based interface, accessible to the users of network computer system 100 via any standard web browser from any computer that is connected to the Internet. Additional details on graphical user interface 224 are presented below.

Those skilled in the art will recognize that other types of information for other types of data that may be used in other applications (e.g., historical, informational, technical, etc.) may be stored and retrieved as well. While database 223 is shown to be residing in main memory 220, it should be noted that database 223 might also be physically stored in a location other than main memory 220. For example, database 223 may be stored on external storage device 270 or DASD 280 and coupled to data server 130 via auxiliary storage I/F 240. Additionally, while shown as a single database 223, those skilled in the art will recognize the database 223 may actually comprise a series of related databases, logically linked together. Depending on the specific application and design parameters, database 223 may take many different forms when implemented.

The most preferred embodiments of network computer system 100 of FIG. 1 will typically include a communication server 225 in main memory 220. Communication server 225 is an automated programmable system that is capable of generating one or more forms of messages or message events. For example, communication server 225 may be configured to send automated email messages or SMS text messages to cell phones. Communication server 225 may also be used to generate hard copy messages (e.g., mail merge letters) that are then sent via standard U.S. Postal Service or some type of commercial message delivery company.

Additionally, communication server 225 may be configured to generate a facsimile message by utilizing fax server and a facsimile modem (not shown this FIG.) that is contained in data server 130 of FIG. 2. Communication server 225 is also capable of being configured and used to send and receive various electronic status messages (e.g. audio and video alerts) and updates to data server 130 and between computers 170, 180, and/or 190 of FIG. 1

In addition, most preferred embodiments of the present invention would include a security and/or encryption mechanism 226 for verifying access to the data and information contained in and transmitted to and from data server 130. Security mechanism 226 may be incorporated into operating system 221 and/or web server 222. Additionally, security mechanism 226 may also provide encryption capabilities for other components of network computer system 100 of FIG. 1, thereby enhancing the robustness of network computer system 100 of FIG. 1. Security mechanism 226 is most preferably configured to protect the integrity and security of the information transmitted via network 120 of FIG. 1.

Further, depending on the type and quantity of information stored in database 223 and accessed by graphical user interface 224, security mechanism 226 may provide different levels of security and/or encryption for different computer systems 170 and 180 of FIG. 1 and the information stored in database 223. The level and type of security measures applied by security mechanism 226 may be determined by the identity of the end-user and/or the nature of a given request and/or response. In some preferred embodiments of the present invention, security mechanism 226 may be contained in or implemented in conjunction with certain hardware components (not shown this FIG.) such as hardware-based firewalls, switches, dongles, and the like.

Document mechanism 227 is a software program or mechanism that uses the information stored in database(s) 223 to create and manage collections of electronic version of paper-based documents and associated metadata. Document mechanism 227 will access the data contained in database(s) 223 and perform various calculations related to document management.

In the most preferred embodiments of the present invention, the various components of network computer system 100 of FIG. 1 are able to communicate using multiple communications protocols and systems (e.g., Voice over IP or “VoIP”, Plain Old Telephone Service or “POTS”, etc.). Those skilled in the art will recognize that the communication protocols used herein may be readily adapted and configured to allow for the rapid and efficient transmission and receipt of data by and between the various components of network computer system 100 of FIG. 1. This would also include the ability to control and customize the input and output of network computer system 100 of FIG. 1 for integration with other systems. While a specific exemplary embodiment of a suitable server 130 has been provided above, those skilled in the art will recognize that many other suitable computers (with more or fewer features) may be substituted for the specific example provided herein within departing from the spirit and scope of the present invention.

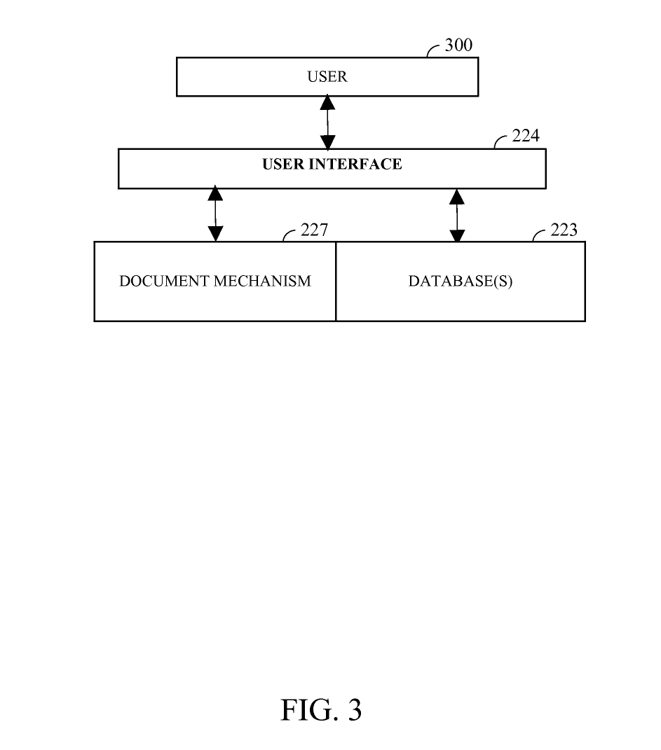

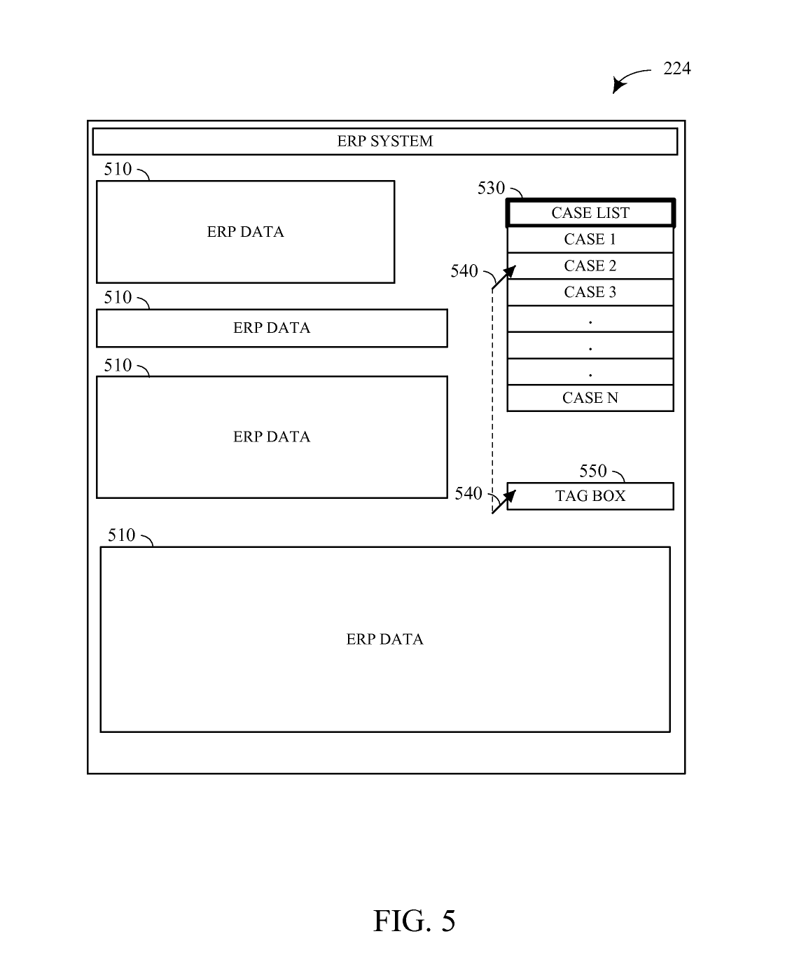

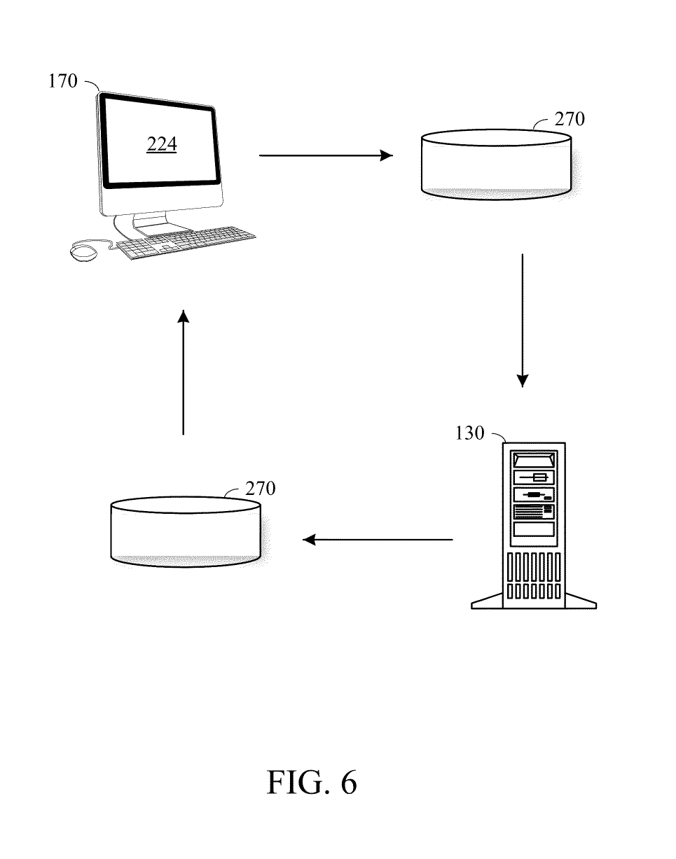

Referring now to FIG. 2 and FIG. 3, a user 300 will interact with user interface 224. By accessing user interface 224, user 300 can input and modify the data contained in database(s) 223. User 300 can also interact with document mechanism 227 to receive information regarding potential related problems and responses. Document mechanism 227 will access the data contained in database(s) 223. Additional information regarding user interface 224 is presented in conjunction with FIG. 5 and FIG. 6.

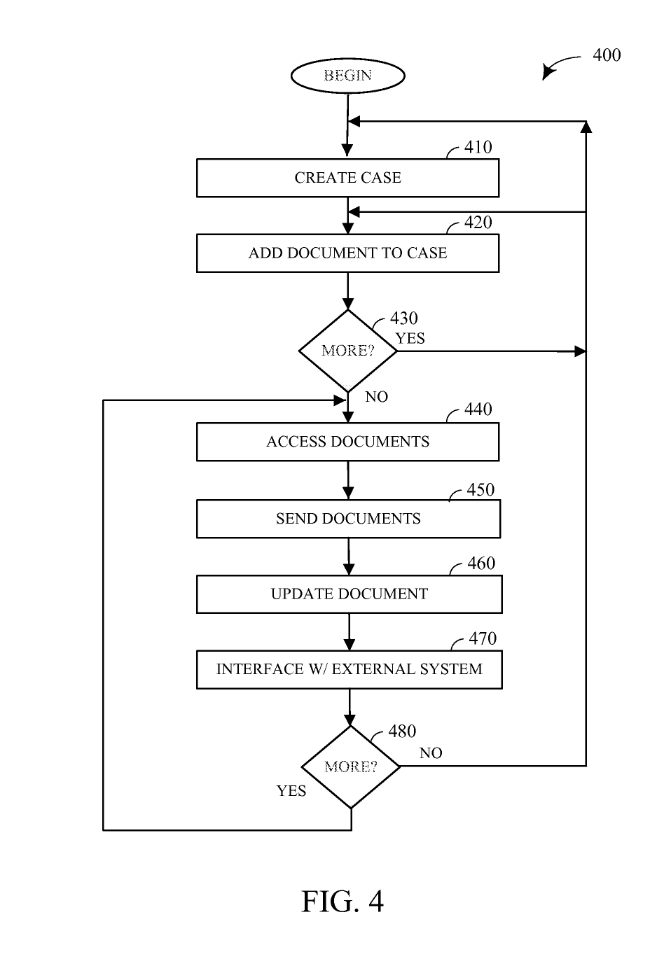

Referring now to FIG. 4, a flow chart for a method 400 for an automated document linking system in accordance with a preferred exemplary embodiment of the present invention is depicted. As shown in FIG. 4, a user will access user interface 224 of FIG. 2 to create a “case” for use with document mechanism 227 of FIG. 2.

In the beginning, a user will create a “case” (step 410). As previously explained, a case is a collection of documents that have been identified by a common case identification. These documents are often digital images of paper-based documents but may include electronic documents as well. Once a case has been created, the user may add one or more documents to the case (step 420) and each document selected for inclusion by the user will be “linked” or associated with that case. It is important to note that any given case will typically have multiple documents associated with it and each document may be associated with multiple cases. In at least one preferred embodiment of the present invention, each user may determine which documents are associated with a given case and their user credentials will load and display their specific variation of a given case. Alternatively, there may be a single version of each case and the inclusion of documents as well as access to documents will be controlled by standard user login and permission credentialing procedures.

The process of adding documents to the case will continue as long as the user desires to add additional documents to the case (step 430=“YES”). Once the user has added all desired documents to the case (step 430=“NO) then the initial creation of the case is complete. The user may access the case at any point in the future and add additional documents to the case as necessary or desired.

Once the documents have been assembled into a case, the user may optionally access one or more documents (step 440), optionally send one or more documents (step 450), optionally update one or more documents (step 460), and optionally interface with an external system to further link the case (and associated documents) to another application (e.g., an ERP system) (step 470). In this fashion, documents may be retrieved electronically from within computer systems that do not provide native support for externally created documents. Additional information about linking a case to an external application is presented in conjunction with FIG. 5 and FIG. 6. This process will continue as long and as frequently or infrequently as the user(s) determine necessary or desired.

Referring now to FIG. 5, a schematic diagram of a user interface 224 for accessing an automated document linking system in accordance with a preferred exemplary embodiment of the present invention is depicted. A common problem with many document imaging systems is that there is no simple way to connect the images captured by the document imaging system with the greater business workflow where the documents were created. For example, there are many ERP systems that have sophisticated workflow models that allow businesses to capture, monitor, and report on various types of data and information. This information is typically used in tactical and strategic decision-making cycles by employees and owners of the business. However, it is also common for many of these ERP models to lack any significant capacity to store and retrieve electronic images of documents associated with the ERP model. This may limit the efficiency of those individuals and organizations that rely on the ERP system.

ERP data 510 represents any type of ERP data (or similar data for other systems) that may be displayed for a user. For example, contact information, ordering information, application information, inventory levels, status updates, etc. as well as other types of data known to those skilled in the art are all forms of ERP data 510. Those skilled in the art will recognize that each screen displaying ERP data 510 may display different data elements and each screen and each data element may have one or more documents associated with that data element (e.g., order form, invoice, intake form, etc.).

Case list 530 is a listing of all possible cases that may be associated with any given ERP data set. As show in FIG. 5, there may be a virtually unlimited number of cases displayed in case list 530.

Tag box 550 is an active screen area that is used to designate which case is to be associated with the ERP data 510. To make a “link” or association between the ERP data 510 displayed on the monitor and a given case, the user will select the desired case from case list 530 (in this example Case 2) and “drag” the desired case to tag box 550 and “drop” it into tag box 550, using a mouse as represented by mouse pointer 540. This will create a logical association or link between the ERP data 510 and the selected case. Each ERP data 510 may be associated with multiple cases and each case may have multiple data elements of ERP data 510 (as displayed by multiple screen images) associated with that case. This allows different users to create associations that are meaningful for their specific needs and application. The specific associations can be tracked and maintained in database 223 and activated based on a user's login or other credentials.

Referring now to FIG. 1, FIG. 2, FIG. 5, and FIG. 6, a schematic diagram of a process flow for an automated document linking system in accordance with a preferred exemplary embodiment of the present invention is depicted. While described in the context of an ERP system, those skilled in the art will recognize that many other business software environments will also be candidates for integration (e.g., CRM systems, etc.). As shown in FIG. 6, a user can access computer system 100 and automated document linking via workstation or computer 170 via user interface 224; which is displayed on the monitor or screen of computer 170.

As explained in conjunction with FIG. 5, the user select the desired case from the list of candidate cases via user interface. The user will then will “drag and drop” the selected case into the tag box displayed in conjunction with the ERP system. This triggers a data capture sequence and the data associated with the ERP record currently displayed on the monitor of computer 170 is captured and stored in a database (e.g., database 223 of FIG. 2) located on external storage mechanism 270. The ERP record data will then be transmitted to server 130 for processing by document mechanism 227. The identification information for the selected case is also transmitted to server 130 for processing by document mechanism 227. Document mechanism 227 will create an association between the ERP data and the selected case, including all of the documents associated with the case. This association is a “link” between the ERP record and the selected case. The link makes all of the documents associated with the case, including documents added to the case after the association is created, accessible from within the ERP system and also from the document imaging system that captured or created the digital documents.

In at least some preferred embodiments of the present invention, the identification of a case with a screen of data, an event is created and an email will be created, using an email template, and then automatically sent to a user. The email template and the specific user or users to receive the email are defined by business rules associate with document mechanism 227.

When an application has been enabled with an interface to a document mechanism 227, the user can navigates to a previously identified form that includes a “tag” button or a “tag” interface in the form of an active area on the screen that has been designated to activate the connection with document mechanism 227.

The user will click on the “tag” button in the business application form (e.g., ERP data entry screen) and a “tag” dialog box will be displayed. This dialog box will allow the user to specify metadata and other information that may be useful for later document retrieval and analysis purposes. The user drags and drops the email message from the email client to the “tag” dialog box.

A form action is then executed and the “document” and associated metadata from the active database record is sent to a document import folder on server 130 that has been designated to receive the data. Document mechanism 227 accepts the email formatted message (e.g., a .msg file) and then processes the document.

The document mechanism 227 will parse the body of the email message for a hidden key and read it (that is unique to the KwikTag case we are associating with the database record). It should be noted that the token or key is defined in the email template during the population of the email message prior to transmission to server 130.

Once the key is found, document mechanism 227 will look up the specific case that the message was originated from and associate the appropriate case to the database record it was “tagged” or associated with. It will also add the new metadata (including new index keys) to the index list of items for the case.

From the foregoing description, it should be appreciated that a system and method for automated document linking disclosed herein presents significant benefits that would be apparent to one skilled in the art. Furthermore, while multiple embodiments have been presented in the foregoing description, it should be appreciated that a vast number of variations in the embodiments exist. Lastly, it should be appreciated that these embodiments are preferred exemplary embodiments only and are not intended to limit the scope, applicability, or configuration of the invention in any way. Rather, the foregoing detailed description provides those skilled in the art with a convenient road map for implementing a preferred exemplary embodiment of the invention, it being understood that various changes may be made in the function and arrangement of elements described in the exemplary preferred embodiment without departing from the spirit and scope of the invention as set forth in the appended claims.

1. A network computer system comprising:
at least one processor;
at least one memory coupled to the at least one processor;
a database residing in the memory; and
a document mechanism residing in the memory, the document mechanism being configured to create a connection between a pre-existing document collection and a database record.

2. The network computer system of claim 1 further comprising an email template containing a hidden key that identifies the database record, the pre-existing document collection, and a link between the database record and the pre-existing document collection.

3. The network computer system of claim 1 further comprising a user interface for accessing the database record and the pre-existing document collection, the user interface providing an active screen area designated for creating the link between the database record and the pre-existing document collection.

4. The network computer system of claim 1 further comprising a case list, the case list presenting a list comprising a plurality of cases, wherein each of the plurality of cases comprises a plurality of documents.

5. The network computer system of claim 1 wherein the connection between the pre-existing document collection and the database record is created by dragging a case from a case list and dropping the case onto an active area of the screen.
